(19) United States
(12) Patent Application Publication
(10) Pub. No.: US 2012/0199448 A1
(43) Pub. Date: Aug. 9, 2012

(54) SHORT-TRAVEL KEY

(75) Inventors: Martin Zimmer, Friedrichshafen (DE); Roger Birost, Ravensburg (DE)

(73) Assignee: Liebherr-Elektronik GmbH, Lindau (DE)

(21) Appl. No.: 13/369,155

(22) Filed: Feb. 8, 2012

(30) Foreign Application Priority Data
Feb. 9, 2011 (DE) 10 2011 010 760.6

(51) Int. Cl. H01H 13/02

(52) U.S. Cl. 200/42.01

(57) ABSTRACT

The present disclosure relates to a short-travel key comprising a touch body for actuating the short-travel key, wherein at least two redundantly arranged microswitches are provided which are actuable via the touch body and wherein the short-travel key has only one tactile pressure point.

### CROSS REFERENCE TO RELATED APPLICATION

This application claims priority to German Patent Application No. 10 2011 010 760.6, entitled “Short-Travel Key”; filed Feb. 9, 2011, which is hereby incorporated by reference in its entirety for all purposes.

### TECHNICAL FIELD

The present disclosure relates to a short-travel key which comprises a touch body for actuating the short-travel key.

### BACKGROUND AND SUMMARY

Generic short-travel keys have a touch body accessible to the user. The pushing pressure effects a movement of the touch body which cooperates with a microswitch to trigger a corresponding switch state. The microswitch can be either of an electrical or mechanical nature.

So-called tactile short-travel keys prove to be advantageous when a feedback to the key operator is required. Tactile short-travel keys have a pressure point which is tactile for the operator and which communicates the successful triggering of the switch state. As a rule, the reaching of the pressure point is additionally assisted by an acoustic sound, for example by a click or the like.

The generic short-travel keys are in particular used with functional keyboards or special control panels. Such keyboards or control panels are in particular used in work machines as input devices for the direct control of the machine. The increasing safety requirements in the industry also cover the design of the keyboards or control panels used. The functional security is guaranteed in that the key function can no longer be triggered on a failure of one or more components. An unwanted incorrect operation (malfunction), caused by a component error of the key, is thereby avoided.

While taking the above into account, it is the object of the present disclosure decisively to increase the functional security and operating security of a generic short-travel key significantly by a direct further development thereof.

This object is achieved by a short-travel key having a touch body which serves the actuation of the short-travel key. In accordance with the present disclosure at least two redundantly arranged microswitches are provided. The microswitches arranged redundantly to one another, in particular short-travel microswitches, are in contact with the touch body and can be actuated by the travel movement of the actuated touch body. The key function is only ensured when both microswitches are contacted.

One or more microswitches work in accordance with a mechanical and/or electrical switching principle. The switching principles of at least some of the microswitches used can differ from one another or can be identical. Exactly two microswitches may be arranged redundantly to one another.

The feedback of the short-travel key for signaling the successful switch actuation should be unambiguous despite the redundantly designed microswitches. Provision is therefore made in accordance with the present disclosure that the short-travel key only has a tactile pressure point. The arrangement of the redundantly designed microswitches accordingly takes place such that only a single tactile pressure point can be felt despite the parallel actuation of the at least two microswitches.

The touch body used is optionally of parallelepiped shape, in particular cuboid, with the lower side coming into contact with the microswitches to actuate them. In the unloaded state, i.e. without an effect of force of the operator, the touch body expediently contacts at least one microswitch.

The upwardly disposed front side of the touch body is optionally cut out for inserting a touch cap. The touch cap forms the pressure point for the operator of the short-travel key.

The requirement of providing the short-travel key with a single tactile pressure point is advantageously achieved in that the short-travel key includes a single tactile microswitch and at least one non-tactile microswitch. The pressure point noticeable for the operator is accordingly only generated by the tactile microswitch.

There is optionally only a contact between the non-tactile microswitch(es) and the touch body in the unloaded state.

It can be advantageous to arrange at least one support surface at the touch body in such a manner as to limit the maximum possible travel movement of the touch body for the microswitch actuation. The touch body is in contact with the movably supported switch element of the microswitch optionally designed as a pressure switch. The pressure of the touch body exerted onto the switch element or pressure element of the microswitch triggers a switching state change on reaching a defined pressure level. The contact between at least one support surface and the fixed part of the microswitch limits the maximum travel of the touch body. A complete pressing in of the microswitch pressure element is suppressed, which contributes to the saving of material of the short-travel microswitches used.

In a particularly advantageous embodiment of the short travel key, at least one support surface is not arranged centrally in the region of all microswitches, but rather off-center in the contact region of the touch body with the non-tactile microswitch(es). The resulting only contact of the support surface with the non-tactile microswitch(es) effects a lever arm function of the support surface. The touch body is inclined in the direction of the tactile microswitch, which improves the function of the short-travel key in the interaction of both microswitches.

At least one guide is advantageously provided at the touch body and is in engagement with at least one microswitch. A stable position of the touch body on the microswitch(es) is achieved by the guide. A centration of the touch body on the non-tactile short-travel microswitch is in particular achieved. This allows the guidance of the touch body over the total height up to the front plate cut-out of the touch body, which improves the function of the short-travel key and excludes the risk of jamming. A ball guide has proved particularly advantageous.

One or more webs standing perpendicular on the touch body surface are in particular arranged on the side of the touch body facing the microswitch. The webs simplify the installation of the short-travel key in accordance with the present disclosure, in particular the equipping of the microswitches fastened to a circuit board with the corresponding touch body. The webs advantageously have a conical extent with a periphery converging starting from the touch body. The webs expediently form the corner points of an imaginary rectangle which accepts the at least two microswitches in its middle.

It is conceivable that the microswitches and the touch body are arranged such that a defined switching order of the microswitches is followed on their interaction. It can be expedient that the microswitches are not switched simultaneously, but with a travel delay by the touch body.

The switching order is advantageously fixed such that first the non-tactile microswitch is triggered by the touch body and the tactile microswitch is actuated with a travel delay. It is ensured in this manner that a tactile feedback only takes place after the successful switching state change of both microswitches.

The present disclosure further relates to a keyboard or to a control panel having at least one short-travel key in accordance with one of the above-explained feature combinations. The keyboard or the control panel evidently has the same advantages and properties as the previously described short-travel key so that a repeated explanation will be omitted at this point.

Further advantages and particulars of the present disclosure will be explained in detail with reference to an embodiment shown in the drawings.

### BRIEF DESCRIPTION OF THE FIGURES

FIG. 1 shows a perspective lower view of the touch body of the short-travel key in accordance with the present disclosure.

FIG. 2 shows the short-travel key in accordance with the present disclosure in a plan view.

FIG. 3 shows a cross-sectional representation of the short-travel key in accordance with the present disclosure.

FIG. 4 shows a perspective cross-sectional representation of the short-travel key in accordance with the present disclosure.

FIG. 5 shows a schematic representation of the functional principle of the short-travel key in accordance with the present disclosure. FIGS. 1-4 are drawn approximately to scale, although other dimensions are possible.

### DETAILED DESCRIPTION

The present application relates to a short-travel key that may be positioned in a device 8, such as a functional keyboard or a special control panel. Such keyboards or control panels may be positioned in a work machine (such as a crane, for example) as an input device for the direct control of the machine. As such, element 8 may represent a keyboard, control panel, a keyboard positioned in a work machine, and/or a control panel positioned in a work machine.

The perspective representation of FIG. 1 shows the touch body 10 of the short-travel key in accordance with the present disclosure in a view from below. The touch body 10 has roughly almost a cuboid shape; with the side walls of the touch body 10 forming the hollow space 13 in the interior space. The upper side or front plate of the touch body is completely cut-out for receiving a releasable touch cap. The downwardly lying side surface 11 of the touch body 10 is let piece-wise into the hollow space 13 of the touch body 10 while forming the projecting margin 12.

Furthermore, the two support surfaces 40 are arranged on the lower side 11 close to the margin and disposed on a common axis. Four conical webs 51 are furthermore fastened close to the margin and project perpendicular from the lower side 11 and terminate with the margin 12.

The ball guide 60 which is arranged at the same spacing centrally between two conical webs next to the support surfaces 40 serves as a connection means between the touch body and the microswitches 20, 30. The ball guide 60 ensures a stable and central positioning of the touch body 10 on the non-tactile short-travel microswitch 30. For equipping, the touch body is placed from above onto the two microswitches and is fixed sufficiently via the ball guide to the non-tactile short-travel switch 30.

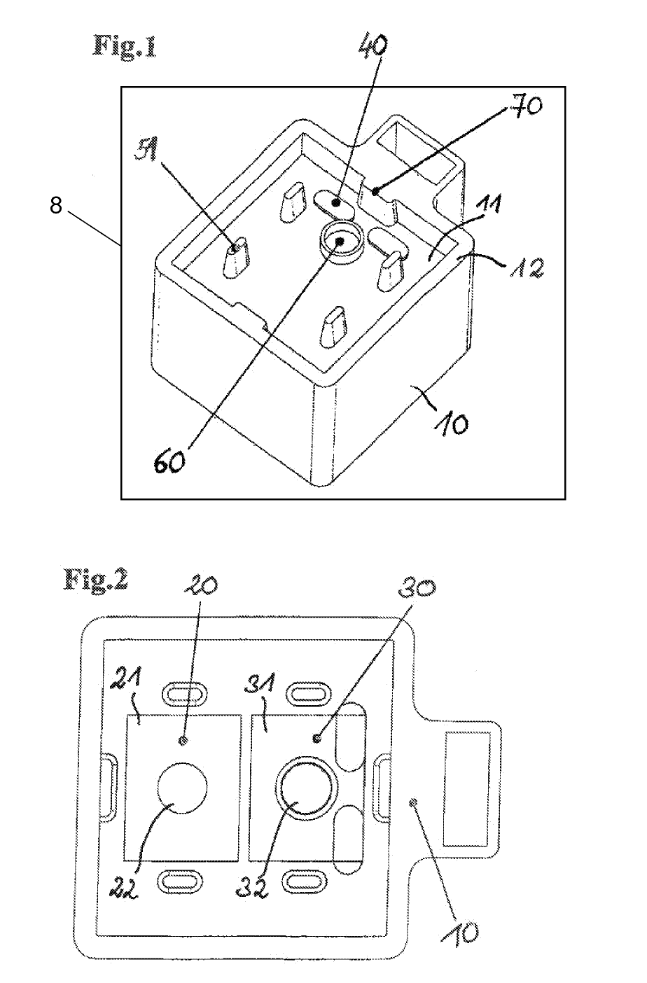

FIG. 2 shows a plan view of the short-travel key in accordance with the present disclosure. In the embodiment shown, the short-travel key is shown without a touch cap and fiber optics for illuminating the touch cap. The Figure allows a view through the cut-out front plate into the hollow space 13 of the touch body 10 up to the two short-travel microswitches 20, 30.

The microswitches 20, 30 made as pressure switches can easily be recognized in detail in the Figure. The microswitches each include a fixed switch element 21, 31 and a pressure element 22, 32 movably supported thereon for switch actuation. The pressure force introduced onto the touch body 10 or onto the fastened touch cap effects a travel movement of the touch body in the direction of the microswitches 20, 30 whose pressure elements 22, 32 are pressed into the fixed switch elements 21, 31 from the lower side 11 of the touch body.

Both microswitches can work in accordance with an electric or mechanical switching principle.

In the assembled state, the microswitches 20, 30 lie aligned adjacent and parallel to one another in the region between the four conical webs 51 arranged symmetrically to one another. A corresponding preceding parallel and adjacent alignment of the microswitches on the circuit board 50 is necessary for the following equipping with the touch body 10.

The microswitch 30 is designed as a non-tactile microswitch and the microswitch 20 as a tactile microswitch. Only the tactile microswitch 20 has a pressure point tangible for the operator. In addition, the tactile microswitch 20 can output a click for signaling the switching state change. Furthermore, it can be seen from FIG. 2 that only the non-tactile microswitch 30 or the fixed switch element 31 lies in the contact region of the support surfaces 40.

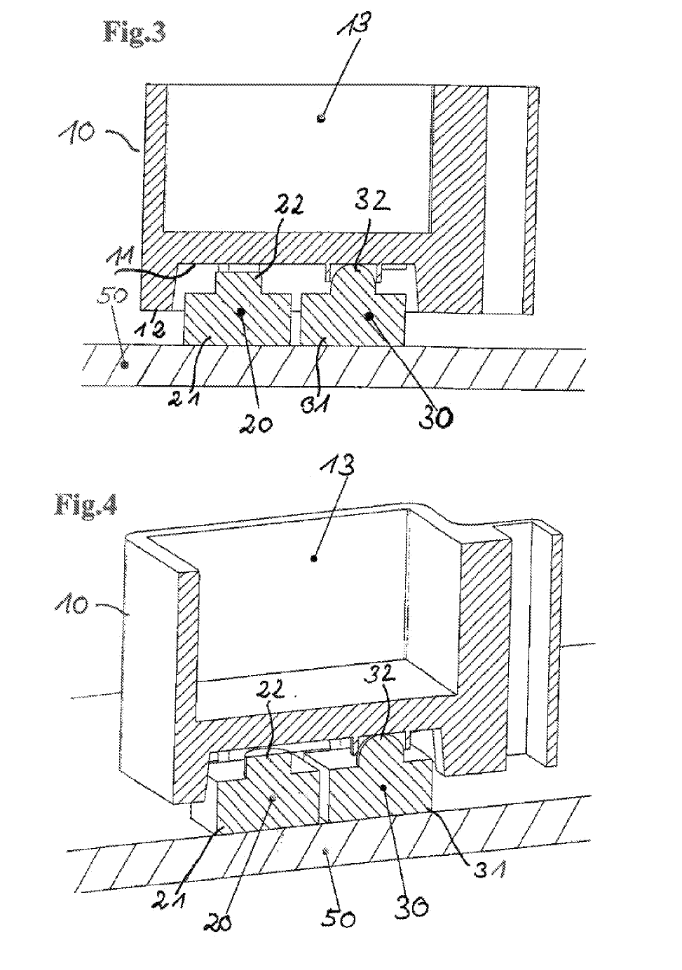

FIGS. 3, 4 show a cross-section of the short-travel key in accordance with the present disclosure, with FIG. 3 showing a side view of the cross-section and FIG. 4 showing a perspective view of the cross-section. Both representations show the short-travel key without the touch cap and corresponding fiber optics. The two microswitches are electrically connected, in particular soldered, to the circuit board 50.

In both FIGS. 3, 4, the movably supported pressure elements 22, 32 can be easily recognized which are in direct contact with the lower side 11 of the touch body 10. The travel movement of the touch body 10 generated by the effect of force presses the pressure elements 22, 32 into the fixed switch elements 21, 31 of the microswitches 20, 30. The ball guide 60 contributes to the sufficient guidance of the touch body 10 over the total height up to the front plate cut-out, which improves the function of the short-travel key and precludes the risk of jamming during the travel movement.

The conical webs 51 and the two conical noses 70, which are integrated in the margin 12, serve as an installation aid in the equipping of the corresponding microswitches 20, 30 with the touch body 10.

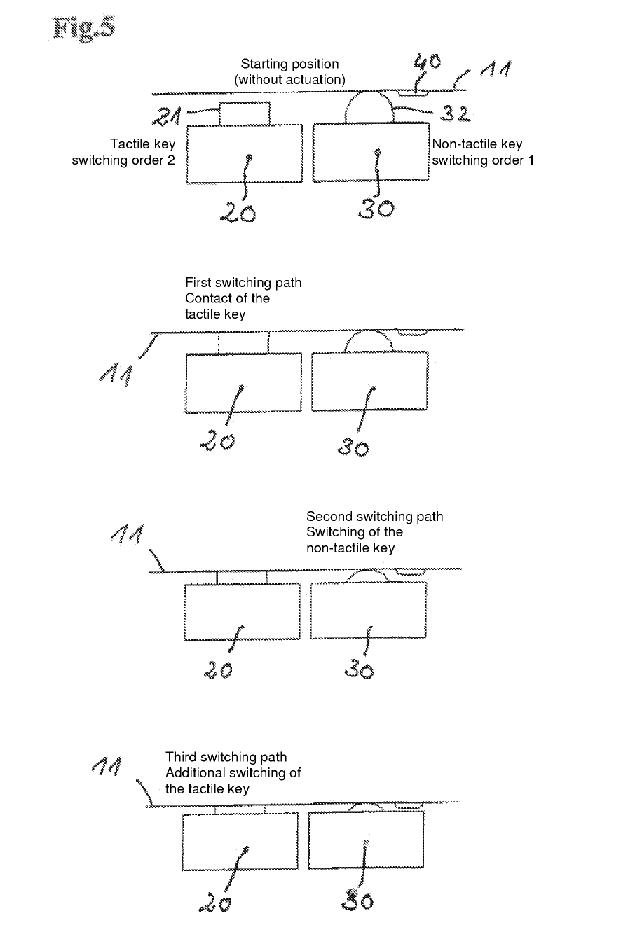

FIG. 5 shows a schematic representation of the operation of the short-travel key in accordance with the present disclosure. In the starting position, that is in the pressure-relieved position of the touch body 10, the lower side 11 of the touch body is only in contact with the pressure element 32 of the non-tactile microswitch 30. The switching order of the short-travel key in accordance with the present disclosure is defined in this respect so that first the non-tactile microswitch 30 should be triggered until then the tactile microswitch 20 is actuated with travel delay. The schematic representation in FIG. 5 divides the switching process of the short-travel key in accordance with the present disclosure which takes place into the three chronologically shown switching paths.

In the first switching path, the touch body 10 is moved in the direction of the microswitches 20, 30 by the exertion of force onto the touch body so that the pressure element 32 of the non-tactile microswitch 30 is pressed into the fixed switch element 31 until a contact is established between the pressure element 22 of the tactile microswitch 20 and the lower side 11 of the touch body 10.

In the second switching path, the touch body 10 is moved so far in the direction of the microswitches 20, 30 until the switching state of the non-tactile microswitch 30 is triggered. The adjoining third switching path comprises the triggering of the tactile microswitch 20 due to the continuing travel movement of the touch body, with a tactile feedback to the operating person of the touch body 10 taking place. In addition, an assisting acoustic feedback can be output in the form of a click.

The support 40 is in contact with the fixed switch element 31 of the non-tactile microswitch 30 and limits the maximum travel movement of the touch body 10. A complete pressing in of the pressure elements 22, 32 is hereby successfully suppressed, whereby both short-travel microswitches 20, 30 are protected. The off-center arrangement of the support surfaces 40 furthermore acts as a lever arm mechanism. The corresponding arrangement effects a tilting of the touch body 10 in the direction of the tactile short-travel microswitch 20, which improves the function of the short-travel switch in the interaction of both microswitches 20, 30.

1. A short-travel key comprising:
a touch body for actuating the short-travel key, wherein at least two redundantly arranged microswitches are provided which are actuable via the touch body, with the short-travel key having only one tactile pressure point.

2. A short-travel key in accordance with claim 1, wherein the micro switches arranged redundantly to one another include a tactile microswitch and at least one non-tactile microswitch.

3. A short-travel key in accordance with claim 2, wherein at least one support surface is arranged at the touch body such that a maximum travel movement of the touch body for the microswitch actuation is limited.

4. A short-travel key in accordance with claim 3, wherein the support surface only comes into contact with the non-tactile microswitch(es) to achieve an inclined position of the touch body with respect to the microswitches in the direction of the tactile microswitch.

5. A short-travel key in accordance with claim 1, wherein at least one guide is provided at the touch body which is in engagement with at least one microswitch.

6. A short-travel key in accordance with claim 1, wherein one or more webs are arranged at the touch body to simplify the installation of the touch body on the microswitches belonging to the short-travel key.

7. A short-travel key in accordance with claim 1, wherein the microswitches and the touch body are arranged so that a defined switching order of the microswitches is followed on their interaction.

8. A short-travel key in accordance with claim 7, wherein on the actuation of the short-travel key, the switching order first provides a triggering of a non-tactile microswitch, followed by the triggering with travel delay of a tactile microswitch.

9. The short-travel key in accordance with claim 5, wherein the guide is a ball guide.

10. The short-travel key in accordance with claim 6, wherein the one or more webs includes conical webs.

11. The short-travel key in accordance with claim 1, wherein the short-travel key is positioned in a keyboard.

12. The short-travel key in accordance with claim 1, wherein the short-travel key is positioned in a control panel of a work machine.

13. A short-travel key comprising:
a touch body for actuating the short-travel key, wherein at least two redundantly arranged microswitches are provided which are actuable via the touch body, with the short-travel key having only one tactile pressure point, the short-travel key positioned in a work machine, wherein the microswitches arranged redundantly to one another include a tactile microswitch and at least one non-tactile microswitch.

14. A short-travel key in accordance with claim 13, wherein at least one support surface is arranged at the touch body such that a maximum travel movement of the touch body for the microswitch actuation is limited.

15. A short-travel key in accordance with claim 14, wherein the support surface only comes into contact with the non-tactile microswitch(es) to achieve an inclined position of the touch body with respect to the microswitches in the direction of the tactile microswitch.

16. A short-travel key in accordance with claim 15, wherein at least one guide is provided at the touch body which is in engagement with at least one microswitch.

17. A short-travel key in accordance with claim 15, wherein the microswitches and the touch body are arranged so that a defined switching order of the microswitches is followed on their interaction.

18. A short-travel key in accordance with claim 17, wherein on the actuation of the short-travel key, the switching order first provides a triggering of a non-tactile microswitch, followed by the triggering with travel delay of a tactile microswitch.

19. The short-travel key in accordance with claim 18, wherein the guide is a ball guide.

20. The short-travel key in accordance with claim 19, wherein the one or more webs includes conical webs.
